(19) United States
(12) Patent Application Publication
(10) Pub. No.: US 2026/0048285 A1
(43) Pub. Date: Feb. 19, 2026

(54) FIRE-EXTINGUISHING AGENT DROPPING DEVICE FOR FIRE SUPPRESSION

(71) Applicant: Kwonpyo HONG, Namyangju-si (KR)

(72) Inventor: Kwonpyo HONG, Namyangju-si (KR)

(21) Appl. No.: 19/231,859

(22) Filed: Jun. 9, 2025

(30) Foreign Application Priority Data
Aug. 14, 2024 (KR) 10-2024-0109163

(51) Int. Cl. A62C 3/02; F42B 12/46

(52) U.S. Cl. CPC A62C 3/025; F42B 12/46

(57) ABSTRACT

Disclosed herein is a fire-extinguishing agent dropping device for fire suppression. The fire-extinguishing agent dropping device includes: a body configured such that an accommodation chamber is formed therein; an altitude detection part provided in the body, and configured to detect a preset reference height; a pressure generation part provided in the front area of the accommodation chamber, and configured to generate an explosion pressure when the altitude detection part detects the reference height; and a plurality of fire-extinguishing agent accommodation parts provided in the rear area of the accommodation chamber, and configured to store a fire-extinguishing agent therein.

### CROSS-REFERENCE TO RELATED APPLICATION

This application claims the benefit of Korean Patent Application No. 10-2024-0109163 filed on Aug. 14, 2024, which is hereby incorporated by reference herein in its entirety.

### BACKGROUND

### 1. Technical Field

The present invention relates to a fire-extinguishing agent dropping device for fire suppression, and more specifically, to a fire-extinguishing agent dropping device for fire suppression that is capable of dropping a fire-extinguishing agent over a wide area at the location where a fire occurs.

### 2. Description of the Related Art

In wide natural environments that are not easily accessible to humans, initial fire suppression and disaster prevention are considerably important. Most fires can be effectively suppressed in the early stages, but fires in natural environments such as forest fires are considerably difficult to suppress in the early stages.

When a forest fire occurs, it takes at least 30 minutes for firefighters to receive a report and arrive at the scene of the fire. During this time, the forest fire spreads uncontrollably.

In particular, in the case of remote mountainous areas with poor accessibility, it is not easy for firefighters and firefighting facilities to access the areas. Furthermore, it is difficult to respond rapidly when a forest fire occurs in a natural environment such as a national park or forest. Accordingly, there is a problem in that the natural environment cannot be protected.

As a related art document related to the present invention, there is Korean Patent No. 10-1838392 (published on Feb. 21, 2018), which discloses a fire fighting water facility management system and method.

### SUMMARY

An object of the present invention is to provide a fire-extinguishing agent dropping device for fire suppression that is capable of dropping a fire-extinguishing agent over a wide area at the location where a fire occurs.

According to an aspect of the present invention, there is provided a fire-extinguishing agent dropping device for fire suppression, the fire-extinguishing agent dropping device including: a body configured such that an accommodation chamber is formed therein; an altitude detection part provided in the body, and configured to detect a preset reference height; a pressure generation part provided in the front area of the accommodation chamber, and configured to generate an explosion pressure when the altitude detection part detects the reference height; and a plurality of fire-extinguishing agent accommodation parts provided in the reara area of the accommodation chamber, and configured to store a fire-extinguishing agent therein; wherein the fire-extinguishing agent accommodation parts are separated out of the body to discharge the fire-extinguishing agent by an explosion pressure when the pressure generation part is operated.

The altitude detection part may detect an atmospheric pressure according to the altitude when the body is falling freely.

The fire-extinguishing agent dropping device may further include a rear support plate inserted into the accommodation chamber and configured to close the rear of the rear area and support the fire-extinguishing agent accommodation parts forward at the front surface thereof, a front support plate positioned in front of the rear support plate and configured to close the front of the rear area and support the rear side of the fire-extinguishing agent accommodation parts rearward at the rear surface thereof, and a connection beam coupled to the rear surface of the front support plate and the front surface of the rear support plate on both sides thereof in the lengthwise direction thereof and configured such that the fire-extinguishing agent accommodation parts are positioned along the widthwise direction thereof; and the front support plate may slide rearward and be then separated rearward from the accommodation chamber by a propulsion pressure applied to the front surface thereof when the pressure generation part is operated.

The fire-extinguishing agent accommodation parts may each include an accommodation space provided therein and formed to be open to one side and a stopper coupled to one side and configured to close the accommodation space, and the stopper may be separated to open the accommodation space when the fire-extinguishing agent accommodation part is separated from the accommodation chamber.

The fire-extinguishing agent accommodation parts may be arranged in a state of being in close contact with each other along the front-rear direction, may be positioned between the rear and front support plates, and may also be arranged along the widthwise direction of the connection beam.

The present invention has advantages in that it may prevent casualties during a fire suppression process because it may extinguish a fire (a forest fire, a building fire, or the like) from a distance without requiring the approach of firefighters, may improve fire suppression performance because it may drop the fire-extinguishing agent at a location close to the location where a fire occurs, and may efficiently suppress a large fire because it may spread the fire-extinguishing agent over a wide area.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a perspective view showing a fire-extinguishing agent dropping device for fire suppression according to the present invention;

FIG. 2 is an exploded perspective view showing the fire-extinguishing agent dropping device for suppression according to the present invention;

FIG. 3 is an exploded perspective view showing the rear support plate, front support plate, connection beam, and fire-extinguishing agent accommodation parts of the fire-extinguishing agent dropping device for fire suppression according to the present invention;

FIG. 4 is a sectional view showing the fire-extinguishing agent dropping device for fire suppression according to the present invention when viewed from the side;

FIG. 5 is a sectional view showing the states of the separated components of the fire-extinguishing agent dropping device for fire suppression according to the present invention when viewed from the side;

FIG. 6 is a sectional view showing the fire-extinguishing agent dropping device for fire suppression according to the present invention when viewed from the rear;

FIG. 7 is a sectional view showing a state in which the fire-extinguishing agent dropping device for fire suppression according to the present invention is dropped toward the location of a fire;

FIG. 8 is a sectional view showing a state in which the pressure generation part of the fire-extinguishing agent dropping device for fire suppression according to the present invention is operated and separates the fire-extinguishing agent accommodation parts from the outside of the body;

FIG. 9 is a perspective view showing a state in which stoppers after the fire-extinguishing agent accommodation parts of the fire-extinguishing agent dropping device for fire suppression according to the present invention have been separated from the body;

FIG. 10 is a sectional view showing a state in which a spiral groove is applied to the fire-extinguishing agent dropping device for fire suppression according to the present invention;

FIG. 11 is a sectional view showing a state in which the rear support plate, the front support plate, and the connection beam are rotated by the spiral groove of the fire-extinguishing agent dropping device for fire suppression according to the present invention;

FIG. 12 is a sectional view showing a state in which an auxiliary accommodation space is applied to the fire-extinguishing agent dropping device for fire suppression according to the present invention;

FIG. 13 is a sectional view showing a state in which the front support plate of the fire-extinguishing agent dropping device for fire suppression according to the present invention is separated and the fire-extinguishing agent of the auxiliary accommodation space is discharged;

FIG. 14 is a sectional view showing a state in which seating depressions, auxiliary fins, and elastic members are applied to the fire-extinguishing agent device for fire dropping suppression according to the present invention;

FIG. 15 is a sectional view showing a state in which the auxiliary fins of the fire-extinguishing agent dropping device for fire suppression according to the present invention are unfolded by the compressive elastic force of the elastic members;

FIG. 16 is a sectional view showing a state in which dropping posture adjustment parts and cables are applied to the fire-extinguishing agent dropping device for fire suppression according to the present invention; and

FIG. 17 is a sectional view showing a state in which the dropping posture adjustment parts of the fire-extinguishing agent dropping device for fire suppression according to the present invention are unfolded.

### DETAILED DESCRIPTION

Embodiments of the present invention will be described in detail below with reference to the accompanying drawings

Advantages and features of the present invention and methods for achieving them will become clear with reference to the embodiments to be described in detail below in conjunction with the accompanying drawings.

However, the present invention is not limited to the embodiments to be disclosed below, but may be implemented in various different forms. These embodiments are provided only to ensure that the disclosure of the present invention is complete and to fully inform those having ordinary skill in the art, to which the present invention pertains, of the scope of the invention, and the present invention is defined only by the scope of the claims.

In addition, when it is determined that a detailed description of a related known technology or the like may obscure the gist of the present invention when the present invention is described, the detailed description will be omitted.

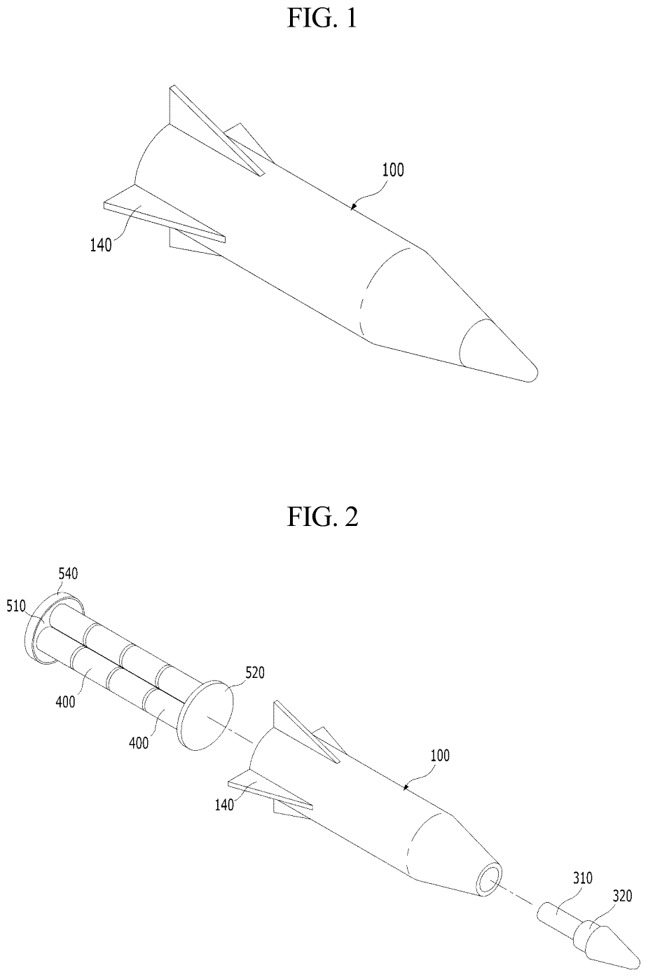

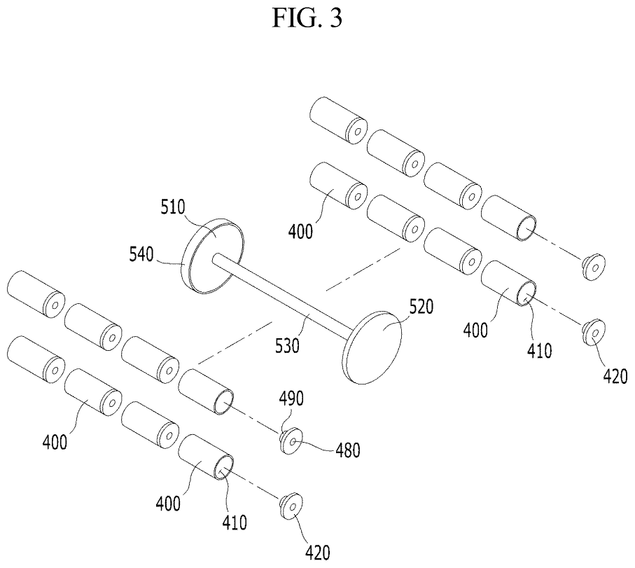

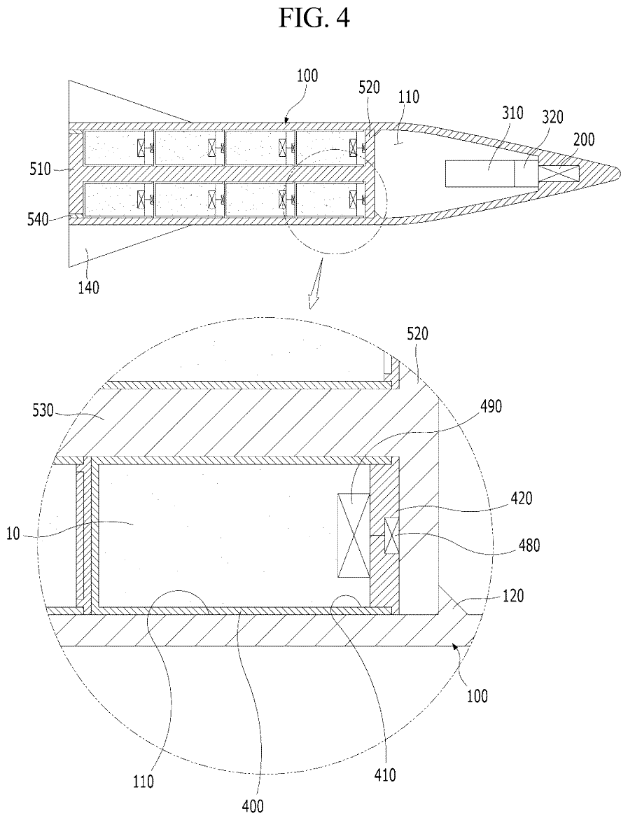

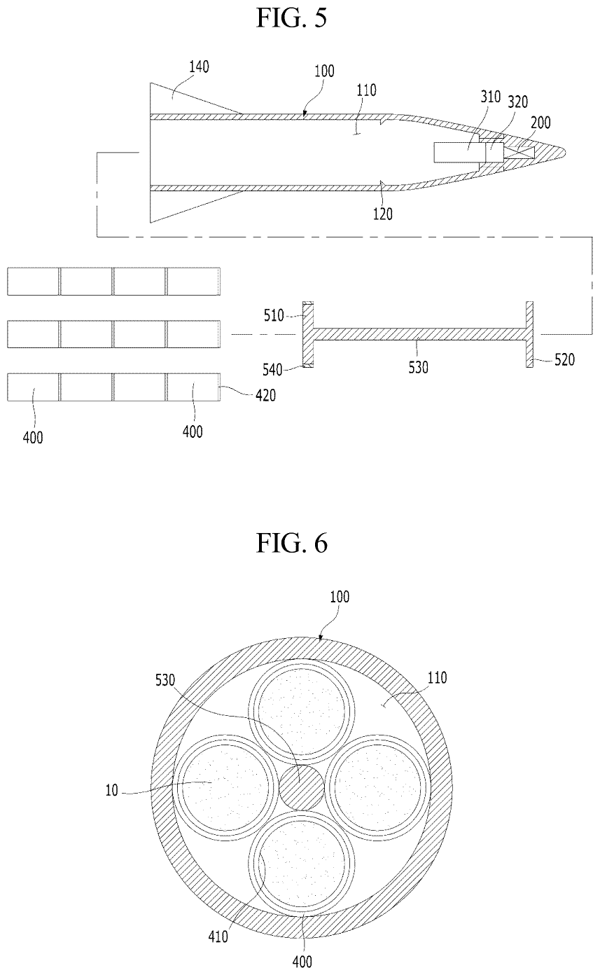

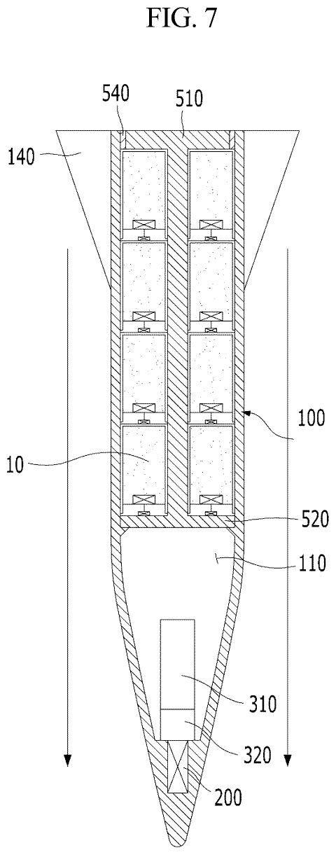

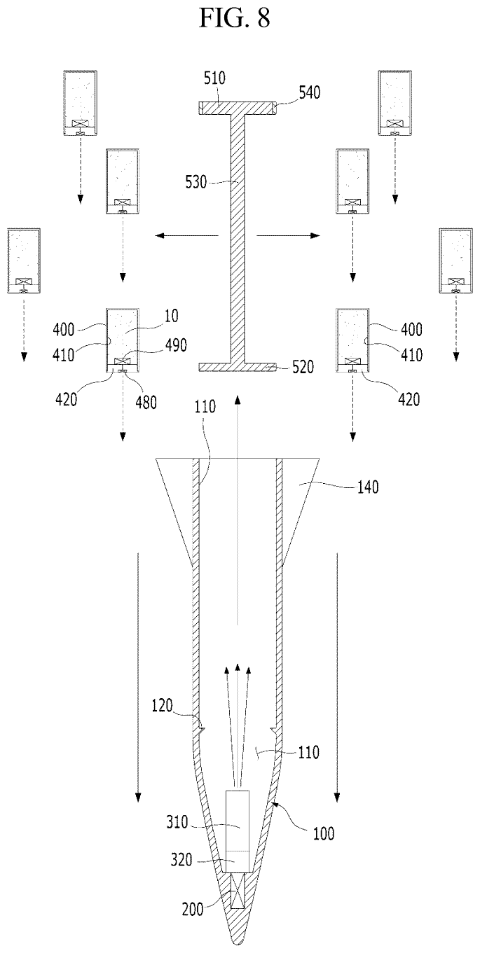

FIG. 1 is a perspective view showing a fire-extinguishing agent dropping device for fire suppression according to the present invention, FIG. 2 is an exploded perspective view showing the fire-extinguishing agent dropping device for fire suppression according to the present invention, FIG. 3 is an exploded perspective view showing the rear support plate, front support plate, connection beam, and fire-extinguishing agent accommodation parts of the fire-extinguishing agent dropping device for fire suppression according to the present invention, FIG. 4 is a sectional view showing the fire-extinguishing agent dropping device for fire suppression according to the present invention when viewed from the side, FIG. 5 is a sectional view showing the states of the separated components of the fire-extinguishing agent dropping device for fire suppression according to the present invention when viewed from the side, FIG. 6 is a sectional view showing the fire-extinguishing agent dropping device for fire suppression according to the present invention when viewed from the rear, FIG. 7 is a sectional view showing a state in which the fire-extinguishing agent dropping device for fire suppression according to the present invention is dropped toward the location of a fire, and FIG. 8 is a sectional view showing a state in which the pressure generation part of the fire-extinguishing agent dropping device for fire suppression according to the present invention is operated and separates the fire-extinguishing agent accommodation parts from the outside of the body.

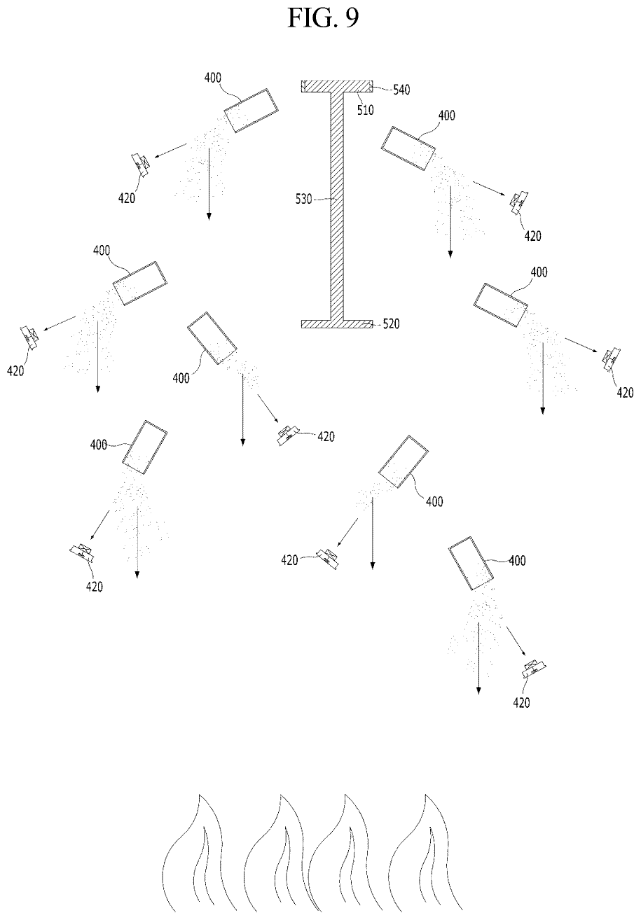

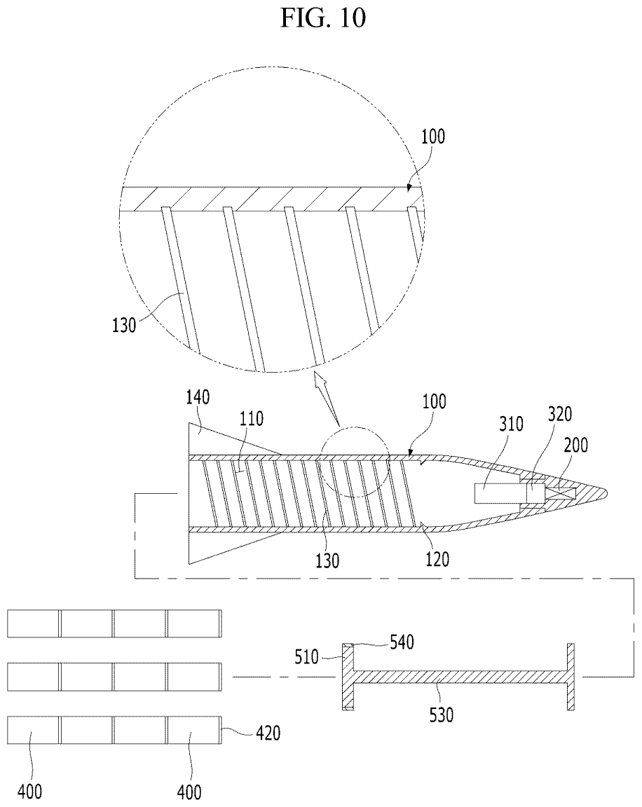

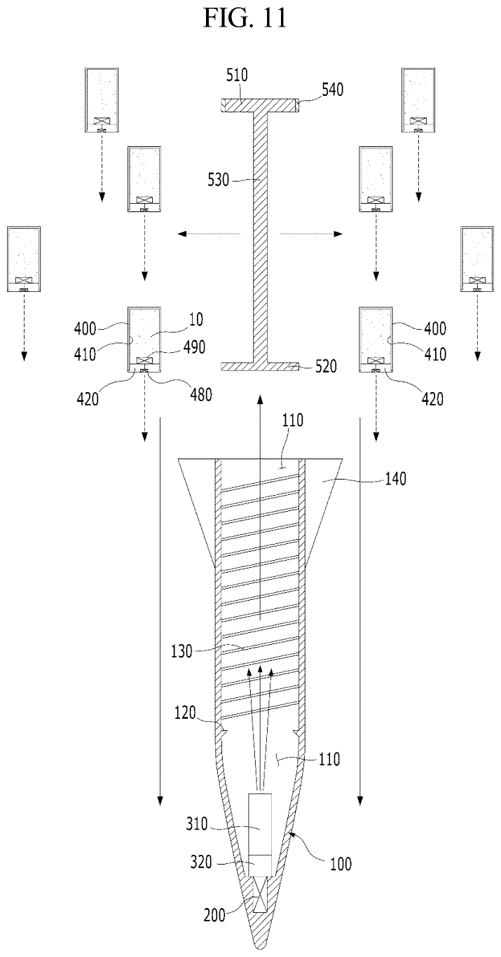

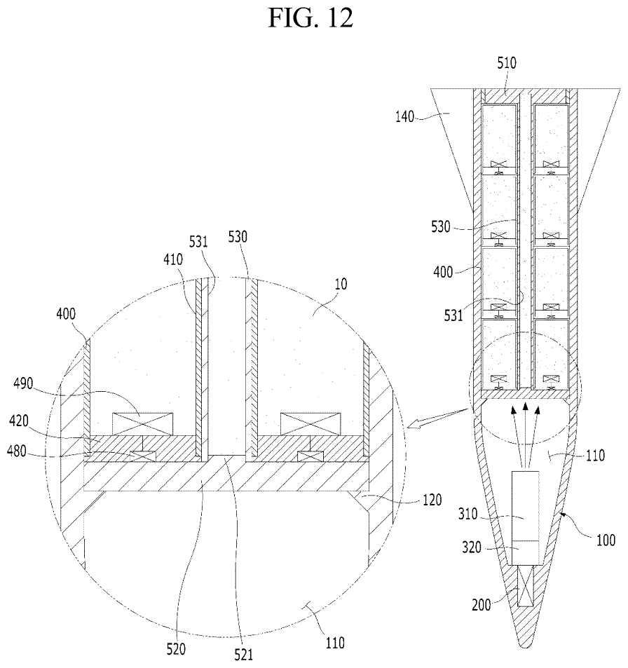

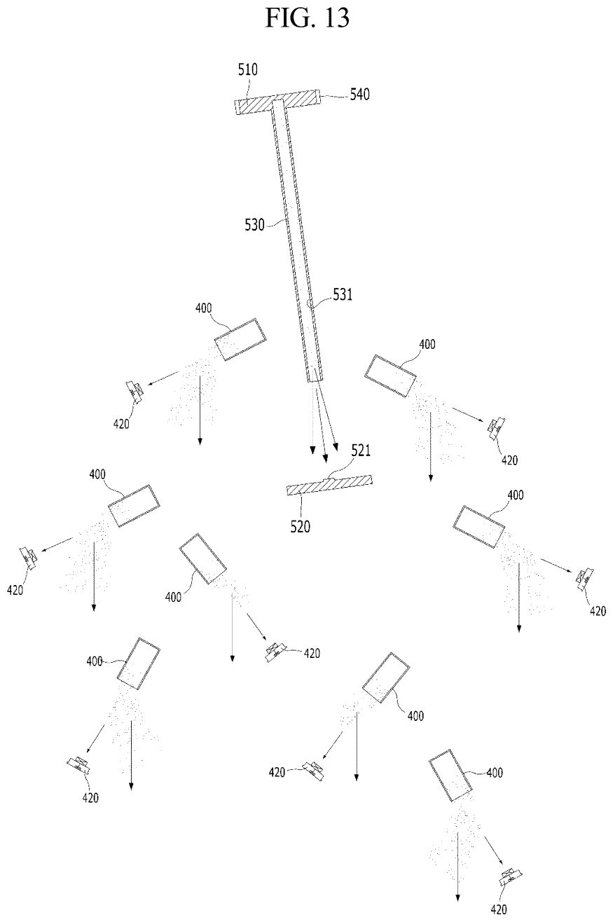

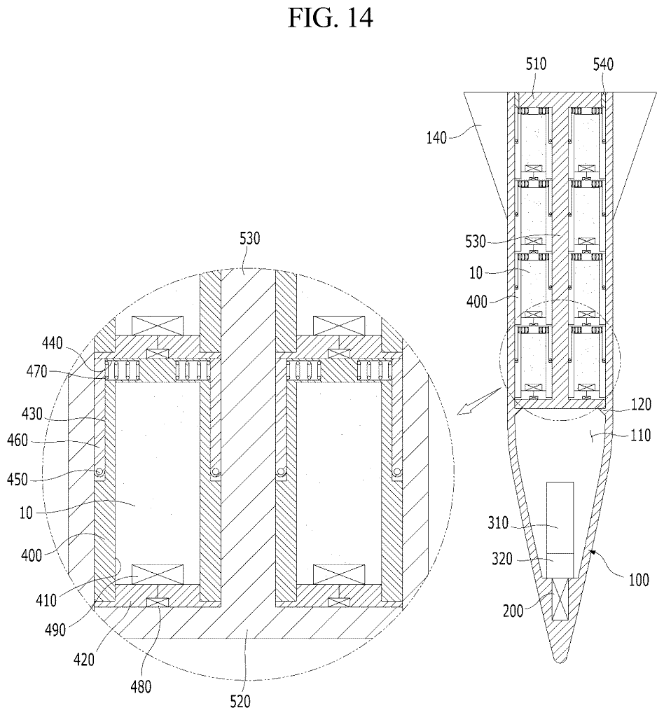

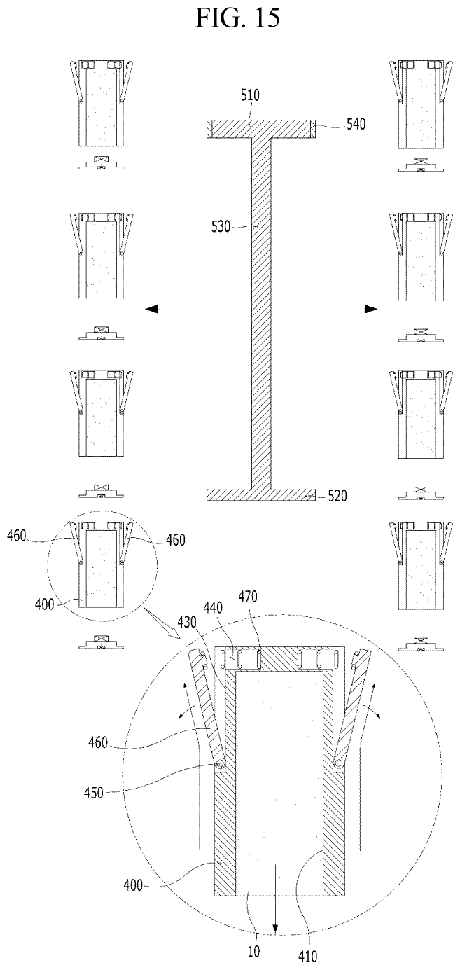

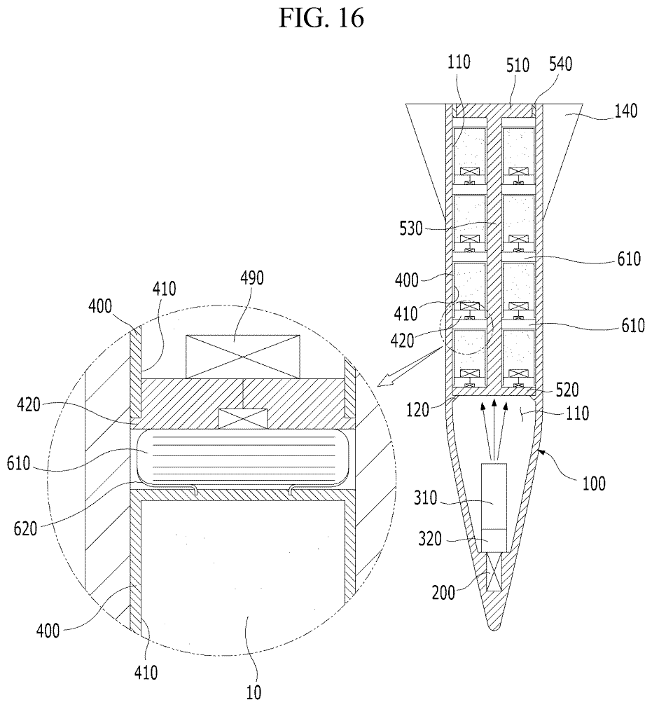

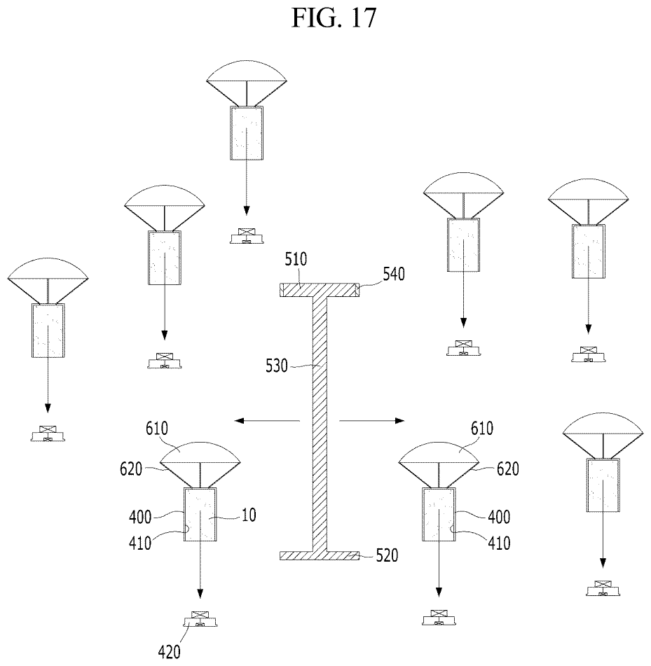

FIG. 9 is a perspective view showing a state in which stoppers are removed after the fire-extinguishing agent accommodation parts of the fire-extinguishing agent dropping device for fire suppression according to the present invention have been separated from the body, FIG. 10 is a sectional view showing a state in which a spiral groove is applied to the fire-extinguishing agent dropping device for fire suppression according to the present invention, FIG. 11 is a sectional view showing a state in which the rear support plate, the front support plate, and the connection beam are rotated by the spiral groove of the fire-extinguishing agent dropping device for fire suppression according to the present invention, FIG. 12 is a sectional view showing a state in which an auxiliary accommodation space is applied to the fire-extinguishing agent dropping device for fire suppression according to the present invention, FIG. 13 is a sectional view showing a state in which the front support plate of the fire-extinguishing agent dropping device for fire suppression according to the present invention is separated and the fire-extinguishing agent of the auxiliary accommodation space is discharged, FIG. 14 is a sectional view showing a state in which seating depressions, auxiliary fins, and elastic members are applied to the fire-extinguishing agent dropping device for fire suppression according to the present invention, FIG. 15 is a sectional view showing a state in which the auxiliary fins of the fire-extinguishing agent dropping device for fire suppression according to the present invention are unfolded by the compressive elastic force of the elastic members, FIG. 16 is a sectional view showing a state in which dropping posture adjustment parts and cables are applied to the fire-extinguishing agent dropping device for fire suppression according to the present invention, and FIG. 17 is a sectional view showing a state in which the dropping posture adjustment parts of the fire-extinguishing agent dropping device for fire suppression according to the present invention are unfolded.

Referring to FIGS. 1 to 17, the fire-extinguishing agent dropping device for fire suppression according to the present invention is intended to drop a fire-extinguishing agent (fire-extinguishing powder, fire-extinguishing liquid, and/or the like) while freely falling toward a location where a fire occurs (the location of a forest fire, a building fire, or the like). The fire-extinguishing agent dropping device for fire suppression according to the present invention includes a body 100, an altitude detection part 200, a pressure generation part 300, and a plurality of fire-extinguishing agent accommodation parts 400.

ABC powder may be used as the fire-extinguishing agent 10 to effectively extinguish fires that occur in wood, oil, clothing, etc. In other words, when a forest fire occurs, the pine resin contained in the tree has the characteristic of not being extinguished easily like oil, so that it is desirable to use a fire-extinguishing agent 10 having excellent fire suppression performance, such as ABC powder.

The body 100 is dropped from a predetermined height by a means of a flight (an airplane, a helicopter, or the like). The body 10 may have a length from front to back so that it can fall while maintaining a vertical posture during free fall, and may also have a shell shape that forms a curved surface (a circumferential surface, or the like) in the widthwise direction.

In this case, the body 100 may have a circumferential surface in the widthwise direction, and the front part of the body 100 may have a tapered shape in which the diameter thereof gradually decreases in the direction toward the front. An accommodation chamber 110 having a predetermined width is formed inside the body 100.

The accommodation chamber 110 may be opened rearward from the body 100, and may be maintained in a closed state by a rear support plate 510 to be described later. The inner peripheral surface of the accommodation chamber 110 facing the widthwise direction of the body 110 may form a circumferential surface. The accommodation chamber 110 has the function of, when a fire is extinguished, being opened rearward and acting as a passage through which the fire-extinguishing agent accommodation parts 400 to be described later are removed.

In addition, a plurality of fins 140 may be coupled to the body 100 along the widthwise direction of the body 100. The fins 140 may be arranged in the rear region of the body 100, and may be radially arranged at equal intervals around the front-back direction of the body 100.

The altitude detection part 200 is provided in the body 100 and configured to detect a preset reference height. The altitude detection part 200 may be coupled within the front end of the body 100, and may detect atmospheric pressure according to the altitude when the body 100 is falling vertically and freely.

In addition, the altitude detection part 200 may be installed in a state of being inserted into the front end of the body 100. The altitude detection part 200 may be electrically connected to a separate power supply unit (not shown). The power supply unit may be installed in a state of being inserted within the thickness of the body 100.

That is, when the body 100 dropped from an aircraft falls vertically and freely, the fire-extinguishing agent 10 may be dropped at a preset reference height through the atmospheric pressure detection of the altitude detection part 200. Since the fire-extinguishing agent 10 is dropped along the same line as the location of a fire, the fire-extinguishing performance may be improved.

In another way, the altitude detection part 200 may use a timer method by which a time is set. In this case, when the altitude detection part 200 is dropped, a timer may be operated, and the altitude detection part 200 may operate the pressure generation part 300 when a preset time has elapsed.

The pressure generation part 300 is intended to release the fire-extinguishing agent accommodation parts 400 of the accommodation chamber 110 out of the body 100 at a dropping position. The pressure generation part 300 is provided in the front region of the accommodation chamber 110, and explodes and transmits pressure rearward when the altitude detection part 200 detects the reference height.

In this case, the pressure generation part 300 may include a housing 310 configured such that air or the like at a set pressure is accommodated in a vacuum state in the inner space thereof, and a fuse 320 coupled to the front of the accommodation chamber 110, positioned in the front area, and configured to be operated by the transmission of an operating signal from the altitude detection part 200 and discharge the pressure, accommodated inside the housing 310, rearward.

The fuse 320 is operated by the transmission of a signal from the altitude detection part 200. The fuse 320 may be electrically connected to the altitude detection part 200, so that an operating signal can be transmitted. The fuse 320 may discharge air pressure rearward by applying an impact or transmitting electrical energy through the inside of the housing 310 when it is operated.

In a different structure, the pressure generation part 300 may have a structure that transmits the propulsion pressure rearward by using the explosive power of gunpowder. In this case, the gunpowder may be accommodated inside the housing 310 and coupled to the rear end of the fuse 320.

In addition, when the gunpowder explodes by the operation of the fuse 320, the propulsion pressure may be applied rearward as the rear end of the housing 310 is opened. That is, as the propulsion pressure generated in the front area of the accommodation chamber 110 by the operation of the fuse 320 can be transferred to the rear area of the accommodation chamber 110, it may be used as the energy for releasing the fire-extinguishing agent accommodation parts 400 to be described later.

The plurality of fire-extinguishing agent accommodation parts 400 are intended to accommodate and drop the fire-extinguishing agent 10, and are provided in the rear area of the accommodation chamber 110. The fire-extinguishing agent (extinguishing powder, extinguishing liquid, and/or the like) is accommodated in the accommodation spaces 410 inside the 10 fire-extinguishing agent accommodation parts 400.

More specifically, the fire-extinguishing agent accommodation parts 400 may each include an accommodation space 410 provided therein and formed to be open to one side, and a stopper 420 coupled to one side of the fire-extinguishing agent accommodation part 400 and configured to close the accommodation space 410.

In this case, the fire-extinguishing agent accommodation part 400 may have a cylindrical shape with a side formed as a circumference and a front and back formed in parallel. In this case, the accommodation space 410 may be opened forward from the fire-extinguishing agent accommodation part 400, and the stopper 420 may be coupled to the front of the accommodation space 410.

The stopper 420 may be separated to open the accommodation space 410 when the fire-extinguishing agent accommodation part 400 is separated from the accommodation chamber 110, and an insertion protrusion configured to be inserted into the front of the accommodation space 410 in a male and female fashion may protrude from one side of the stopper 420.

In this case, the insertion protrusion on one side of the fire-extinguishing agent accommodation part 400 may be fitted into the front of the accommodation space 410 so that the stopper 420 can be easily separated by kinetic energy (rotational power, wind power, and/or the like) when the fire-extinguishing agent accommodation part 400 is separated from the accommodation chamber 110.

For example, as shown in FIGS. 7 to 9, in the case where the fire-extinguishing agent accommodation part 400 is separated from the accommodation chamber 110, the fire-extinguishing agent 10 accommodated in the accommodation space 410 may be discharged to the outside as the stopper 420 is separated by the flow of the fire-extinguishing agent accommodation part 400, and the fire-extinguishing agent 10 is dropped in the process in which the fire-extinguishing agent accommodation part 400 falls freely due to gravity.

In addition, the fire-extinguishing agent dropping device for fire suppression according to one embodiment of the present invention may further include a heat detection unit 480 provided in the fire-extinguishing agent accommodation part 400 and configured to detect the location of a fire below, and a pressure generation unit 490 provided in the fire-extinguishing agent accommodation part 400 and configured to generate an explosion pressure to open the stopper 420 when the heat detection unit 480 detects a temperature equal to or higher than a preset reference temperature.

The heat detection unit 480 may detect the heat below the fire-extinguishing agent accommodation part 400 when the fire-extinguishing agent accommodation part 400 falls freely, and may operate the pressure generation unit 490 when the detected temperature is equal to or higher than a preset reference temperature.

In this case, the heat detection unit 480 may use a temperature sensor using infrared rays and/or the like, and the detection distance and range of the altitude detection unit 200 may be set in various manners as needed.

Furthermore, the heat detection unit 480 may be installed in a state of being inserted into the outside of the fire-extinguishing agent accommodation part 400, the heat detection unit 480 may be electrically connected to a separate power supply unit (not shown), and the power supply unit may be installed in a state of being inserted into the thickness of the fire-extinguishing agent accommodation part 400.

That is, when the fire-extinguishing agent accommodation part 400 dropped from a means of flight falls freely, the fire-extinguishing agent 10 may be dropped at an appropriate height through the temperature detection of the heat detection unit 480, and fire-extinguishing performance may be improved because the fire-extinguishing agent 10 falls along the same line as the location of a fire.

The pressure generation unit 490 is intended to discharge the fire-extinguishing agent 10 accommodated in the fire-extinguishing agent accommodation part 400 to the outside, may be coupled to the inside of the fire-extinguishing agent accommodation part 400 or one side of the stopper 420, and may explode and transmit a pressure rearward when the heat detection unit 480 detects a temperature equal to or higher than the reference temperature.

In this case, the pressure generation unit 490 may include a housing configured such that air or the like at a set pressure are accommodated in a vacuum state, a fuse coupled to the inner surface of the fire-extinguishing agent accommodation part 400 and configured to be operated by the transmission of an operating signal from the heat detection unit 480 and discharge the pressure, accommodated inside the housing, rearward, etc.

In this case, the fuse may be electrically connected to the heat detection unit 480 so that an operating signal can be transmitted thereto, and may discharge air pressure rearward by applying an impact, transmitting electrical energy, or the like.

In a different structure, the pressure generation unit 490 may have a structure that transmits the propulsion pressure rearward by using the explosive power of the gunpowder. In this case, gunpowder may be accommodated inside the housing, and may be coupled to the rear end of the fuse.

In addition, when the gunpowder explodes by the ignition action of the fuse, the rear end of the housing may be opened and the propulsion pressure may be applied rearward. That is, when the explosion pressure is generated by the ignition action of the fuse, the stopper 420 may be separated from the fire-extinguishing agent accommodation part 400, and the fire-extinguishing agent 10 accommodated in the fire-extinguishing agent accommodation part 400 may be discharged to the outside.

Meanwhile, the fire-extinguishing agent dropping device for fire suppression according to one embodiment of the present invention may further include a rear support plate 510 inserted into the accommodation chamber 110 and configured to close the rear of the rear area and support the fire-extinguishing agent accommodation parts 400 forward at the front thereof, a front support plate 520 positioned in front of the rear support plate 510 and configured to close the front of the rear area and support the fire-extinguishing agent accommodation parts 400 rearward at the rear thereof, and a connection beam 530 coupled to the rear of the front support plate 510 and the front of the rear support plate 520 on both sides thereof in the lengthwise direction and configured such that the fire-extinguishing agent accommodation parts 400 are positioned along the widthwise direction.

The rear support plate 510 may have a circular disk shape with an edge forming a circumference. The edge of the rear support plate 510 may be maintained in close contact with the inner circumferential surface of the rear area. The rear support plate 510 may be separated rearward from the accommodation chamber 110 while sliding rearward by the pressure applied from a forward position.

In this case, a ring-shaped sealing member 540 using an elastically deformable material (rubber, silicone, and/or the like) may be coupled to the edge of the rear support plate 510. The sealing member 540 serves to tightly seal a space between the edge of the rear support plate 510 and the inner circumferential surface of the accommodation chamber 110, and may be separated rearward from the accommodation chamber 110 while sliding rearward together with the rear support plate 510.

The front support plate 520 may have a circular disk shape with an edge forming a circumference, and the edge of the front support plate 520 may be maintained in close contact with the inner circumferential surface of the rear area. The front support plate 520 may be separated rearward from the accommodation chamber 110 while sliding rearward by the pressure applied from a forward position. The front area and the rear area may be partitioned in the front-back direction by the front support plate 520.

The front support plate 520 is separated rearward from the accommodation chamber 110 while sliding rearward by the propulsion pressure applied to the front thereof when the pressure generation unit 300 is operated, and the fire-extinguishing agent accommodation parts 400 supported on the rear of the front support plate 520 are also separated together with the front support plate 520 through the rear of the accommodation chamber 110.

In this case, the fire-extinguishing agent accommodation parts 400 may be arranged in a state of being closely aligned in the from-rear direction and positioned between the rear support plate 510 and the front support plate 520, and may also be arranged in a state of being closely aligned in the widthwise direction of the connection beam 530.

In this case, the stoppers 420 of the fire-extinguishing agent accommodation parts 400 may be maintained in a closed state while maintaining a state of being in close contact with the rear ends of fire-extinguishing agent accommodation parts 400 positioned in front thereof, and the stoppers 420 of the fire-extinguishing agent accommodation parts 400 placed at the frontmost positions may be maintained in a closed state while being in close contact with the rear end of the front support plate 520, as shown in FIG. 4.

The fire-extinguishing agent dropping device for fire suppression according to one embodiment of the present invention may further include a spiral groove 130 formed concavely on the inner circumferential surface of the accommodation chamber 110 and extended along the inner circumferential surface of the accommodation chamber 110 in the front-rear direction while forming a spiral shape, as shown in FIGS. 10 and 11.

The spiral groove 130 is intended to allow the rear and front support plates 510 and 520 to be separated rearward from the accommodation chamber 110 while being rotated. When the pressure generation unit 300 is operated, the edges of the front and rear support plates 520 and 510 slide rearward while being in contact with the spiral groove 130.

Thereafter, when the front support plate 520, the rear support plate 510, and the connection beam 530 are separated rearward from the accommodation chamber 110 while being rotated, the plurality of fire-extinguishing agent accommodation parts 400 may be separated in the widthwise direction of the connection beam 530 by centrifugal force.

That is, the plurality of fire-extinguishing agent accommodation parts 400 are separated from the connection beam 530 by centrifugal force, so that the fire-extinguishing agent accommodation parts 400 can be spaced apart from each other over a large area and the plurality of fire-extinguishing agent accommodation parts 400 can be rapidly separated, thereby improving the performance of dropping the fire-extinguishing agent 10.

In addition, the fire-extinguishing agent dropping device for fire suppression according to one embodiment of the present invention may further include an auxiliary accommodation space 531 formed inside the connection beam 530 so that the fire-extinguishing agent 10 is accommodated therein and formed to be open forward from the connection beam 530, as shown in FIGS. 12 and 13. The rear surface of the front support plate 520 described above may come into close contact with the front end of the connection beam 530 and close the front of the auxiliary accommodation space 531.

In this case, an insertion protrusion 521 may protrude from the rear surface of the front support plate 520, and the insertion protrusion 521 may be inserted into the front of the auxiliary accommodation space 531 in a male and female fashion. When the front support plate 520, the rear support plate 510, and the connection beam 530 are separated rearward from the accommodation chamber 110, the front of the auxiliary accommodation space 531 may be opened as the front support plate 520 is separated from the front end of the connection beam 530.

In this case, the fire-extinguishing agent 10 accommodated in the auxiliary accommodation space 531 may be discharged to the outside by the flow of the connecting beam 530. The fire-extinguishing agent 10 discharged from the auxiliary accommodation space 531 and the fire-extinguishing agent 10 discharged from the accommodation spaces 410 of the fire-extinguishing agent accommodation parts 400 may fall to the location of a fire together with fire-extinguishing agent accommodation parts 400. In other words, the internal space of the connection beam 530 may be utilized, thereby increasing the capacity to accommodate the fire-extinguishing agent 10.

Meanwhile, the fire-extinguishing agent dropping device for fire suppression according to one embodiment of the present invention may include a plurality of seating depressions 430 formed concavely along the edges of the fire-extinguishing agent accommodation parts 400 and positioned in the rear regions of the fire-extinguishing agent accommodation parts 400, a plurality of insertion depressions 440 formed concavely from the bottom surfaces of the seating depressions 430, rotational axes 450 forming horizontal rotational centers on both sides of each of the seating depressions 430 and positioned eccentrically in front of the seating depressions 430, a plurality of auxiliary fins 460 correspondingly inserted into the seating depressions 430 and rotatably coupled to the rotational axes 450 at the front ends thereof, and a plurality of elastic members 470 inserted into the insertion depressions 440 and configured to elastically support first surfaces of the auxiliary fins 460 toward the edges of the fire-extinguishing agent accommodation parts 400, as shown in FIGS. 14 and 15.

The auxiliary fins 460 may be maintained in a state of being inserted into the seating depressions 430 in such a manner that the inner surfaces thereof in close contact with the seating depressions 430 are supported by the elastic members 470 and the opposite outer surfaces thereof come into close contact with the inner circumferential surface of the accommodation chamber 110.

The elastic members 470 may have coil spring shapes to apply compressive elastic force toward the edges of the fire-extinguishing agent accommodation parts 400, and both sides of the elastic members 470 may support the bottom surfaces of the insertion depressions 440 and the inner surfaces of the auxiliary fins 460, respectively.

For example, when the front support plate 520, the rear support plate 510, the connection beam 530, and the fire-extinguishing agent accommodation parts 400 are separated, the auxiliary fins 460 may be spread out to the edges of the fire-extinguishing agent accommodation parts 400 while being inclined around the rotational axes 450 by the elastic support force of the elastic members 470, as shown in FIG. 15. The fire-extinguishing agent accommodation parts 400 may be lowered vertically by the resistance force acting on the inclined outer surfaces of the auxiliary fins 460. The accommodation spaces 410 are opened vertically at the same time as the stoppers 420 are separated by gravity, so that the fire-extinguishing agent 10 can be discharged rapidly.

Meanwhile, the fire-extinguishing agent dropping device for fire suppression according to one embodiment of the present invention may further include a plurality of cables 620 configured such that front ends thereof are connected to the rear ends of the fire-extinguishing agent accommodation parts 400, and dropping posture adjustment units 610 configured such that edges thereof are connected to the rear ends of the cables 620, and also configured to come into close contact with the rear ends of the fire-extinguishing agent accommodation parts 400 in a state of being folded and to vertically drops the fire-extinguishing agent accommodation parts 400 by being unfolded due to air resistance when the fire-extinguishing agent accommodation parts 400 are separated from the rear of the accommodation chamber 110, as shown in FIGS. 16 and 17.

The dropping posture adjustment parts 610 each have a structure in which the area in contact with air increases as the fire-extinguishing agent accommodation part 400 is spread out to a wider area when it is separated from the rear of the accommodation chamber 110, and may be fabricated to a specific area by using a material such as fiber so that the volume thereof can be reduced.

In addition, when the fire-extinguishing agent accommodation parts 400 are separated from the rear of the accommodation chamber 110, the dropping speed is adjusted as the dropping posture adjustment parts 610 are unfolded, so that sufficient time for the discharge of the fire-extinguishing agent 10 accommodated in the accommodation spaces 410 can be secured.

As a result, the present invention may prevent casualties during a fire suppression process because it may extinguish a fire (a forest fire, a building fire, or the like) from a distance without requiring the approach of firefighters, may improve fire suppression performance because it may drop the fire-extinguishing agent at a location close to the location where a fire occurs, and may efficiently suppress large fires because it may spread the fire-extinguishing agent 10 over a wide area.

Although the specific embodiments of the fire-extinguishing agent dropping device for fire suppression according to the present invention have been described so far, it is obvious that various modifications may be made within the scope of the present invention.

Therefore, the scope of the present invention should not be defined as being limited to the described embodiments, but should be defined by not only the claims to be described later but also the equivalents of these claims.

That is, the above-described embodiments are to be understood as being exemplary and not restrictive in all respects. The scope of the present invention is to be defined by the claims to be described later rather than the detailed description. All changes or modifications derived from the meanings and scope of the claims and their equivalent concepts should be interpreted as being included in the scope of the present invention.

What is claimed is:

1. A fire-extinguishing agent dropping device for fire suppression, the fire-extinguishing agent dropping device comprising:
a body configured such that an accommodation chamber is formed therein;
an altitude detection part provided in the body, and configured to detect a preset reference height;
a pressure generation part provided in a front area of the accommodation chamber, and configured to generate an explosion pressure when the altitude detection part detects the reference height; and
a plurality of fire-extinguishing agent accommodation parts provided in a rear area of the accommodation chamber, and configured to store a fire-extinguishing agent therein;
wherein the fire-extinguishing agent accommodation parts are separated out of the body to discharge the fire-extinguishing agent by an explosion pressure when the pressure generation part is operated;
wherein the fire-extinguishing agent dropping device further comprises a rear support plate inserted into the accommodation chamber and configured to close a rear of the rear area and support the fire-extinguishing agent accommodation parts forward at a front surface thereof, a front support plate positioned in front of the rear support plate and configured to close a front of the rear area and support the rear side of the fire-extinguishing agent accommodation parts rearward at a rear surface thereof, and a connection beam coupled to a rear surface of the front support plate and a front surface of the rear support plate on both sides thereof in a lengthwise direction thereof and configured such that the fire-extinguishing agent accommodation parts are positioned along a widthwise direction thereof; and
wherein the front support plate slides rearward and is then separated rearward from the accommodation chamber by a propulsion pressure applied to a front surface thereof when the pressure generation part is operated.

2. The fire-extinguishing agent dropping device of claim 1, wherein the altitude detection part detects an atmospheric pressure according to an altitude when the body is falling freely.

3. The fire-extinguishing agent dropping device of claim 1, wherein:
the fire-extinguishing agent accommodation parts each comprise an accommodation space provided therein and formed to be open to one side and a stopper coupled to one side and configured to close the accommodation space; and
the stopper is separated to open the accommodation space when the fire-extinguishing agent accommodation part is separated from the accommodation chamber.

4. The fire-extinguishing agent dropping device of claim 3, wherein the fire-extinguishing agent accommodation parts are arranged in a state of being in close contact with each other along a front-rear direction, are positioned between the rear and front support plates, and are also arranged along a widthwise direction of the connection beam.
